(19) United States
(12) Patent Application Publication
(10) Pub. No.: US 2007/0041180 A1
(43) Pub. Date: Feb. 22, 2007

(54) Portable illumination apparatus

(76) Inventor: Michael B. Wallace, Westmoreland, NY (US)

Correspondence Address: DAVID GIGLIO, ESQ., 231 ELIZABETH STREET, UTICA, NY, 13501, US

(21) Appl. No.: 11/205,485

(22) Filed: Aug. 18, 2005

(51) Int. Cl. F21V 33/00

(52) U.S. Cl. 362/155

(57) ABSTRACT

The present invention provides a portable illumination apparatus that is quickly installed into an existing cupboard or cabinet. The portable illumination apparatus runs on battery power and typically includes incandescent lamps, or LED lamps. An automatic on/off switching unit is responsive to the opening and closing of the cabinet door. In the preferred embodiment, the switching unit includes a protruding member which extends to the cabinet door. When the cabinet door is closed it rotates or depresses the protruding member, which in turn opens the switching unit contacts. When the cabinet door opens, a resilient member within the switching unit forces the contacts closed, thus providing battery power to the lamps, which then become illuminated.

### FIELD OF INVENTION

The present invention relates generally to portable illumination and, more particularly, to a portable illumination apparatus for use in a cabinet or cupboard setting.

### BACKGROUND OF THE INVENTION

There are many types of lighting fixtures for household uses. Room overhead ceiling lights are typically turned on and off by a wall switch or a pull switch. Table lamps typically have a push button or turn button switch.

Refrigerators have an internal lamp which illuminates automatically when the refrigerator door is opened. The refrigerator lamp draws power from the home power grid through internal wiring within the refrigerator. However, this refrigerator lamp is permanently installed and cannot be relocated without taking apart the entire refrigerator and rerouting the wiring.

Night lights are typically plugged directly into a socket and illuminate automatically in response to a room turning dark. Again, the night light requires power from the home power grid and must be plugged into a socket.

Some china closets come replete with internal lamps. An electrical cord extending from the back of the close connects the internal lamp to the home power grid through a wall outlet.

Flashlights are portable lamps that have battery power. However, flashlights are often misplaced and must be hand held. Another problem with this type of lamp is that the user sometimes forgets to turn off the lamp, thus draining the battery dry.

Often times it is desirable to open a cupboard or closet door and to have an illumination level sufficient to see within the cupboard. For example, some people get thirsty at during sleep. Rather than turn the overhead kitchen lights on, and possibly waking other household members, it may be desirable to have a small lamp illuminate within the cupboard holding the glasses.

To provide illumination in most existing cupboards, one would have to first install electrical power within the cupboard. This would be a timely and costly project.

### SUMMARY AND OBJECTS OF THE PRESENT INVENTION

It is an object of the present invention to improve the art of home lighting systems.

It is another object of the present invention to improve the art of providing illumination to existing cupboards or cabinets.

It is yet another object of the present invention to provide a portable illumination apparatus that is simply installed within an existing cabinet.

It is a further object of the present invention to provide a portable illumination apparatus that automatically illuminates when the cabinet door is opened.

It is yet a further object of the present invention to provide a portable illumination apparatus that automatically shuts off when the cabinet door is closed.

These and other features and objects of the present invention are provided in accordance with the present invention in which a portably mountable cabinet illumination apparatus includes a housing having a mountable base and a lens cap which mate with each other. The housing is secured within a cabinet adjacent to a cabinet door. A self contained electrical power source, typically batteries, is disposed within the housing and provides power to at least one lamp.

A switch which is responsive to movement of the cabinet door interrupts the batteries between the lamp. When the door is closed, it causes the switch to open and the power is interrupted to the lamps. Thus, the lamp are not illuminated.

When the door is open, the switch automatically closes thus allowing electrical power to reach the lamp. Hence, the lamp becomes illuminated.

The housing is secured to the cabinet wall by various methods including mating velcro strips or screw mounted.

The switch includes a protruding door engagement member which extends through an opening in the housing, and a pair of contacts. The door engagement member forces the contacts open when cabinet door engages the protruding engagement member in a closing or inward direction.

A resilient member within the switch forces the contacts closed when the cabinet door is swung away from the protruding door engagement member.

### BRIEF DESCRIPTION OF THE DRAWINGS

The present invention will be understood and appreciated more fully from the following detailed description taken in conjunction with the drawings in which:

FIG. 1 is an exploded view of the portable illumination device of the present invention;

FIG. 2 is a cross sectional side view of the portable illumination device of FIG. 1 as installed on an interior cupboard surface;

FIG. 3 is a side elevations view of the portable illumination device of FIG. 1;

FIG. 4 is a top view of the portable illumination device of FIG. 1;

FIG. 5 is an end view of the portable illumination device of FIG. 1;

FIG. 6 is a perspective view of the de-actuation lever in accordance with the preferred embodiment of FIG. 1;

FIG. 7 is a schematic circuit diagram in accordance with a preferred embodiment of the present invention;

FIG. 8 is a side view of a switching unit in accordance with using the present invention wherein a cupboard door is in an open position;

FIG. 9 is a side view of the switching unit of the present invention wherein the cupboard is in a closed position; and

FIG. 10 is a block diagram of an alternative embodiment of the portable illumination device of the present invention.

### DETAILED DESCRIPTION OF A PREFERRED EMBODIMENT OF THE PRESENT INVENTION

The present invention shall now be described in accordance with a preferred embodiment of the present invention which is also depicted in the Figures. As shall become apparent upon a further reading, various modifications to components of the preferred embodiment produces an apparatus that has the same features, effects and functions in the same way.

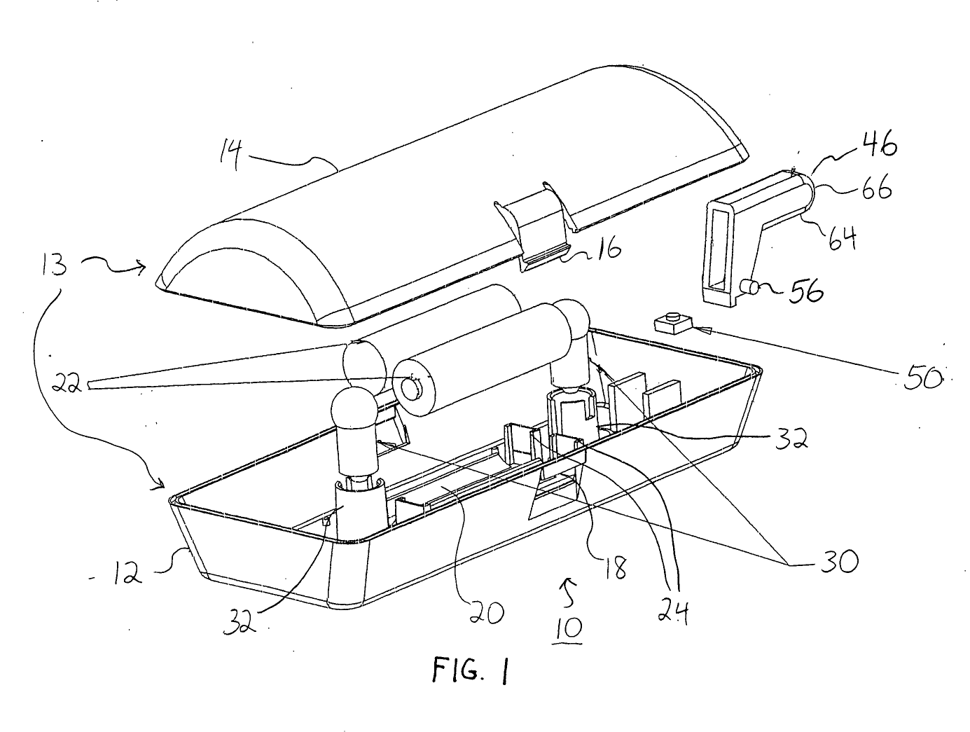

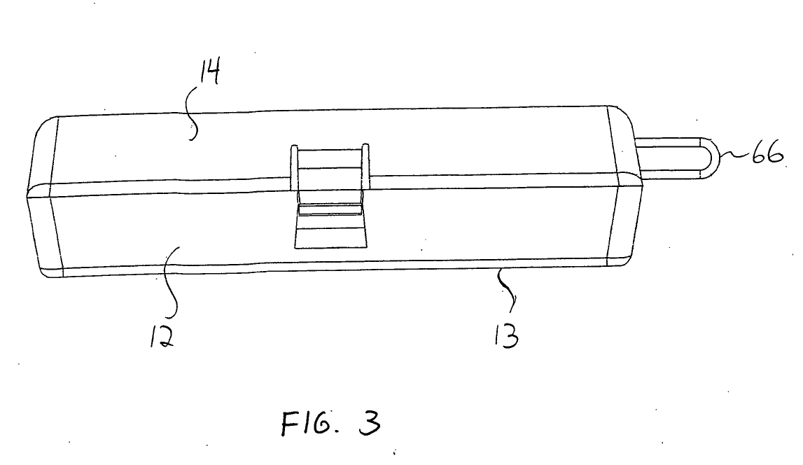

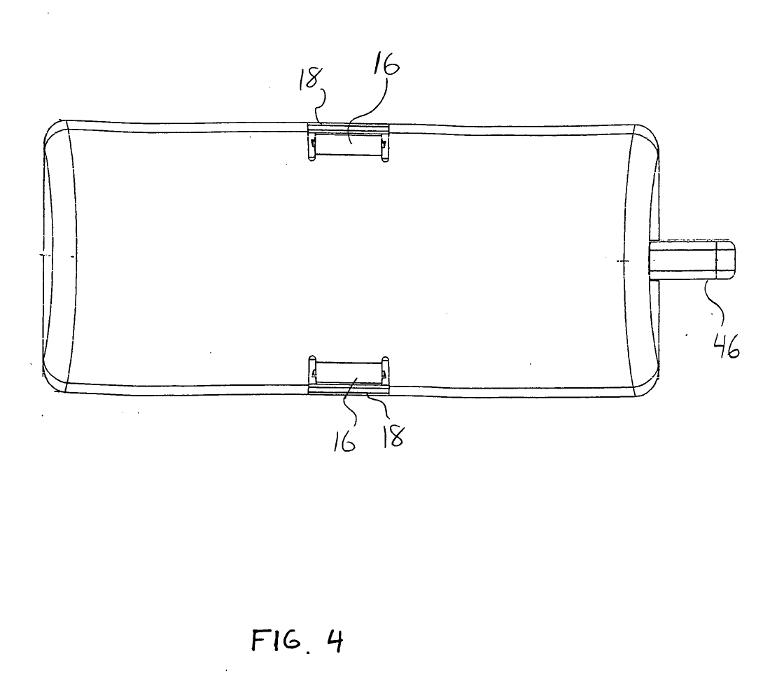

Referring now to FIG. 1, the portable illumination apparatus 10 of a preferred embodiment of the present invention includes a housing 13, also depicted in FIG. 3, which incorporates a mounting base 12 that mates with a lens cap 14. Referring now to both FIGS. 1 and 4, the lens cap 14 includes a pair of opposing tabs 16 which couple with a pair of opposing notches 18 disposed in the mounting base 12.

It should be apparent that various other methods can be used to mate the lens cap 14 to the mounting base 12, including a hinge type apparatus (not shown), screw type mechanisms (not shown) or other suitable mating methods. With the hinge type apparatus, the lens opens or swings away to give access for routine maintenance. The present invention can be made in a variety of sizes and shapes.

The mounting base 12 includes a battery receiving compartment 20 which holds a pair of AA batteries 22 between a pair of electrical battery terminals 24 disposed at each end of the battery receiving compartment 20. Other types of batteries will work as well.

Battery power provides for many advantages. The portable illumination apparatus 10 is easily installed into existing cupboards, tool cabinets and the like. There is no need for any wiring as the apparatus is solely powered via the AA batteries 22.

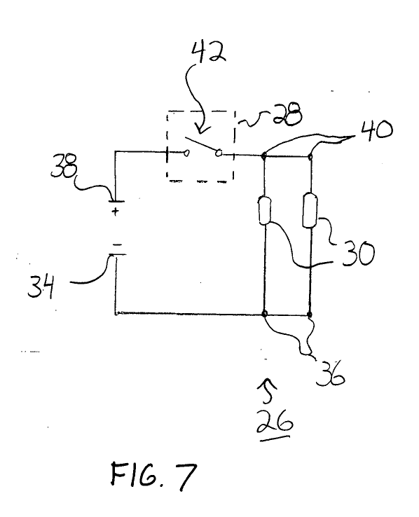

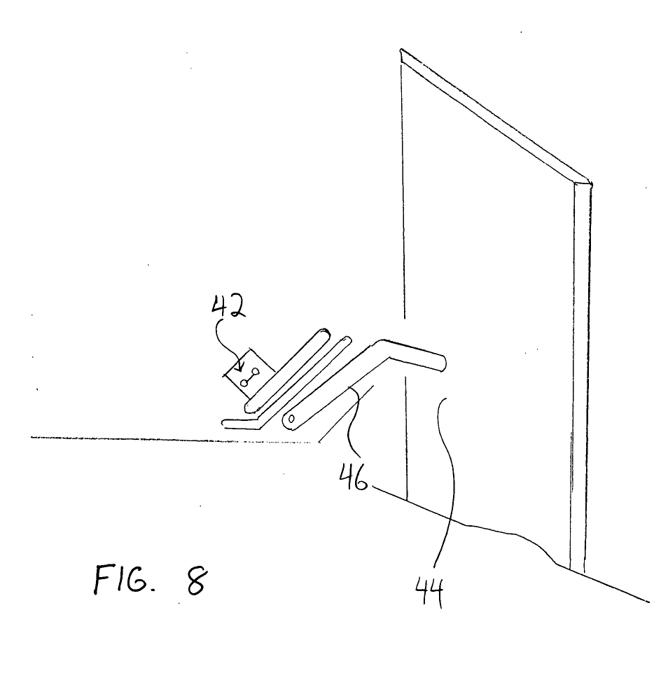

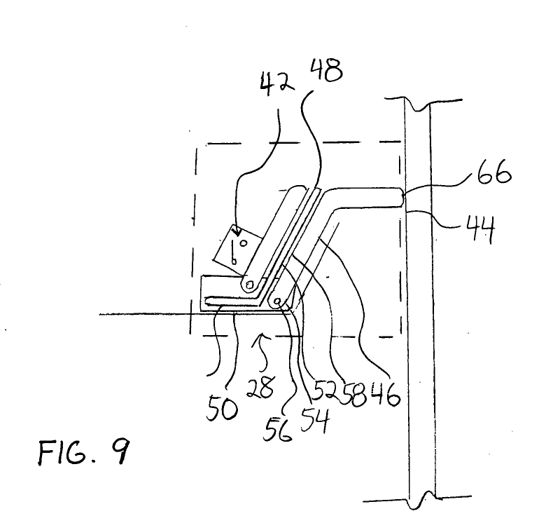

The AA batteries 22 power a lighting circuit 26, schematically depicted in FIG. 7, which is also secured to the mounting base 12. The lighting circuit 26 includes a reverse rocker switching unit 28, a side view of which is depicted in FIGS. 8 and 9, which opens and closes to allow power to reach a pair of incandescent lamps or light emitting diodes 30, which shall be referred to herein by the same numeral. The incandescent lamps or light emitting diodes 30 are fixed within a pair of lamp receptacles 32, depicted in FIG. 1. A negative battery terminal end 34, schematically depicted in FIG. 7, connects to a negative terminal 36 of the lamp receptacles 32, while a positive battery terminal end 38 connects to a positive terminal 40 of the lamp receptacles 32.

The reverse rocker switching unit 28 functions by closing the circuit 26, and allowing electrical power to reach the incandescent lamps or light emitting diodes 30, when the switching unit 28 appears open. Although the reverse rocker switching unit 28 appears open, the contacts 42 within the switching unit 28 are actually closed, which is depicted in FIG. 8.

When the reverse rocker switching unit 28 is depressed, depicted in FIG. 9, such as by closing a cabinet door 44 against the switching unit 28, the reverse rocker switching unit 28 appears physically closed, but the contacts 42 within the switching unit 28 are actually open, and electrical power does not reach the incandescent lamps 30.

In a preferred embodiment, the switching unit 28 is ELPS® part no. SPVD11, although it should be apparent that any number of switches could be successfully implemented in accordance with the present invention.

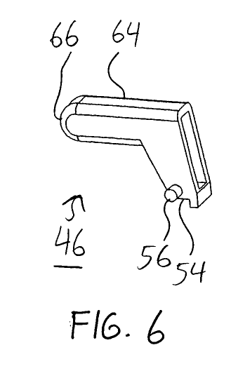

An angularly shaped de-actuating lever 46, also depicted in FIG. 6, is rotatably mounted adjacent to a resilient metal strip 48 of the switching unit 28. The resilient metal strip 48 is mounted at the base 50 of the switching unit 28 and includes a contacting member 52 which extends angularly upward.

The de-actuating lever 46 is mounted adjacent to its base end 54 using a pin 56. The de-actuating lever 46 is angularly shaped so that a first member 58 of the lever 46 substantially conforms to the angle and shape of the contacting member 52 of the resilient metal strip 48.

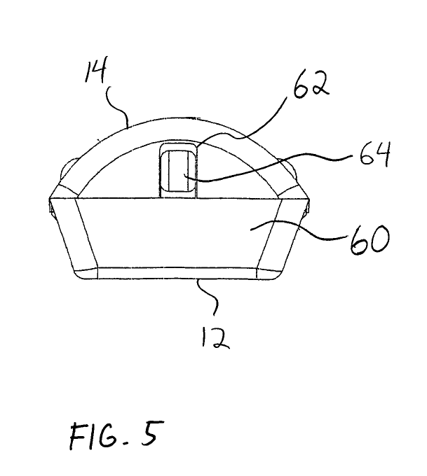

The lens cap 14 and the mounting base 12 form an opening 60 at a first end 62, also depicted in FIG. 5. A protruding member 64 of the de-actuating lever 46 extends through the opening 60. The opening 60 is sized and shaped to allow the protruding member 64 to rotate in an arcuate plane.

The protruding member 64 extends outwardly through the opening 60 in the housing 13. A distal end 66 of the protruding member 64 contacts the cabinet door 44 when the door is in the closed position, depicted in FIG. 9. The door 44 urges the de-actuating lever 46 to rotate angularly inward, thus forcing the resilient metal strip 48 inward to a stressed position, which depresses and opens the electrical contacts 42 in the switching unit 28.

When the cabinet door 44 swings open, the resilient metal strip 48 returns to its normal unstressed position. When the resilient metal strip 48 is in the normal position, depicted in FIG. 8, the contacts 42 in the switching unit 28 close, thus allowing voltage from the batteries 22 to reach the incandescent lamps 30, which in turn become illuminated.

The mounting base 12 is typically injection molded using a plastic material. Likewise, the lens cap 14 is injection molded using a transparent or translucent plastic. For indirect lighting, a reflective material (not shown) is molded into or onto a portion of the lens cap 14. It shall be apparent that other materials may also be utilized, such as glass, to form the mounting base 12 or the lens cap 14.

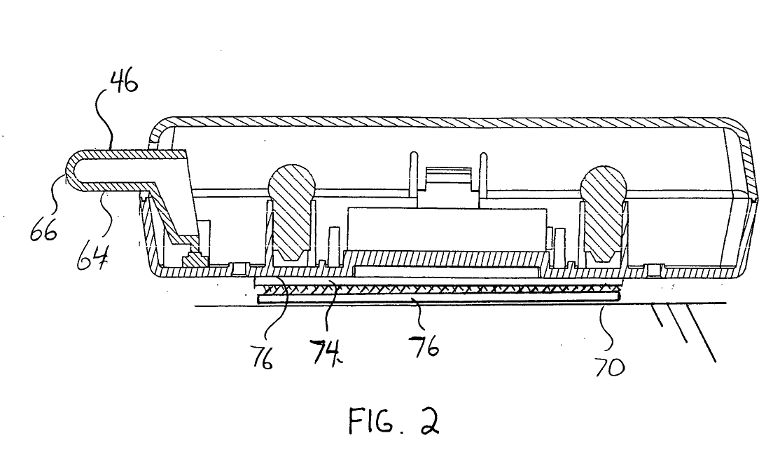

To use the present invention, the mounting base 12 must be secured to an interior surface or cupboard wall 70 of a cupboard or cabinet, with the de-actuating lever 46 facing the cupboard door 44. In a preferred embodiment, depicted in FIG. 2, a first velcro strip 72 having two side tape or glue is mounted to the cupboard wall 70 adjacent to the cupboard door 44 (but not shown in FIG. 2).

A second velcro strip 74 also having two side tape or glue is mounted onto the backside 76 of the mounting base 12. The first and second velcro strips 72, 74are simply mated to secure the portable illumination apparatus 10 to the cupboard wall 70. The mating velcro strips 72, 74 allow for quick and simple adjustment to position the portable illumination apparatus 10 in the optimal placement adjacent the cupboard door.

It should be apparent that a number of mounting methods are obvious and sufficient. For example, the mounting base can include openings (not shown) through which mounting screws (not shown) can be installed.

In place, the cupboard door 44 depresses, or angularly displaces the de-actuating lever 46 and the resilient metal strip 48 of the reverse rocker switching unit 28 to a closed position, when the cupboard door 44 is closed, depicted in FIG. 9. Thus, the contacts 42 open and no power reaches the incandescent bulbs or light emitting diodes 30.

When the cabinet door 44 is opened, depicted in FIG. 8, the resilient metal strip 48 in the reverse rocker switching unit 28 returns to its resting position, thus closing the contacts 42. Electrical power now reaches the incandescent light bulbs 30, which now become illuminated.

On obvious feature of the present invention is the sheer number of applications of the portable illumination apparatus 10. Many homes and offices contain a number of enclosures, cupboards, filing cabinets, tool chests where it is advantageous or desirable to have some level of illumination when access to those enclosure is required. By simply opening the door to the enclosure illumination occurs. There is no need to install any electrical wiring or to manually manipulate any switches. The cupboard door itself serves is the switching implement.

Another feature of the present invention is that it is possible to have illumination during power outages. By simply opening a cupboard door, some level of illumination to the room is achieved from the portable illumination apparatus 10.

Further, the portable illumination apparatus 10 can be unmounted and carried about as a flashlight, and simply re-mounted when the flashlight need is extinguished. One advantage of the present invention is that the portable illumination lamp 10 is easily located as it is always installed in the same position within the cupboard. Thus, the portable illumination lamp 10 is simply removed from the velcro base 72, carried and manually activated.

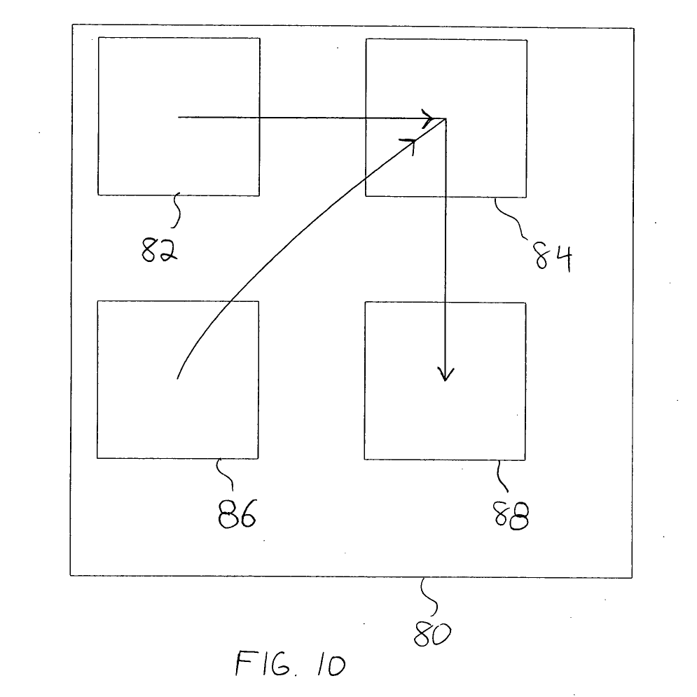

Another type of switching unit that can utilized in accordance with the present invention is a motion sensor switching unit 80, depicted in FIG. 10. In this embodiment, an infrared motion sensor 82 instructs a pair of the switching contacts 84 to close. A pre-set timer 86 determines the amount of time that the lamp 88 remains illuminated.

Various changes and modifications, other than those described above in the preferred embodiment of the invention described herein will be apparent to those skilled in the art. While the invention has been described with respect to certain preferred embodiments and exemplifications, it is not intended to limit the scope of the invention thereby, but solely by the claims appended hereto.

What is claimed is:

1. A portably mountable cabinet illumination apparatus comprising, wherein a cabinet includes at least one door:
a housing;
mounting means for securing said housing to an interior portion of said cabinet a self contained electrical power source disposed within said housing;
at least one illuminating member disposed within said housing and electrically connected to said power source; and
a switching unit disposed within said housing electrically connected between said power source and said at least one illuminating member, said switching unit being responsive to the position of said at least one door wherein said switching unit is closed when said door is in the open position and said switching unit is open when said door is in the closed position.

2. The apparatus of claim 1, wherein said housing further includes a mountable base, a lens cap and mating means for mating said lens cap to said mounting means.

3. The apparatus of claim 1, wherein said mounting means includes a pair of mating velcro members, wherein a first mating velcro member secures to the interior portion of said cabinet and a second mating velcro member secures to an exterior surface of said housing.

4. The apparatus of claim 1, wherein said mounting means includes at least one opening through said housing for accommodating at least one mounting screw.

5. The apparatus of claim 1, wherein said switching unit includes a door engagement member which extends through an opening in said housing, and a pair of contacts, wherein said door engagement member forces said contacts open when said at least one door forces said door engagement member inward.

6. The apparatus of claim 5, wherein said switching unit further includes a resilient member that forces the contacts closed when said at least one door is swung away from said door engagement member.

7. The apparatus of claim 1, wherein said switching unit further includes at least one motion sensor, said motion sensor being responsive to the movement of said at least one door.

8. The apparatus of claim 7, wherein said switching unit further includes a timer having a predetermined time set, such that when said switching unit becomes closed said switching unit automatically opens after said predetermined time set elapses.

9. The apparatus of claim 1, wherein said power source further includes at least one battery.

10. The apparatus of claim 1, wherein said at least one illuminating member is selected from the group consisting essentially of an incandescent lamp and a light emitting diode.

11. A cabinet comprising:
at least one shelf member;
at least one door rotatable about a hinge for accessing said at least one shelf member;
opposing walls for bounding said at least one shelf member on opposing ends;
a top member having an interior surface facing a top surface of said at least one shelf member, said top member being connected to said opposing walls; and
a portably mounted illumination apparatus mounted to an interior member of said cabinet, said illumination apparatus comprising:
a housing;
mounting means for securing said housing to said interior member of said cabinet
a self contained power source disposed within said housing;
at least one illumination member disposed within said housing and electrically connected to said power source; and
a switching unit disposed within said housing electrically connected between said power source and said at least one illuminating member, said switching unit being responsive to the position of said at least one door wherein said switching unit is closed when said door is in the open position and said switching unit is open when said door is in the closed position.

12. The apparatus of claim 11, wherein said mounting means includes a pair of mating velcro members, wherein a first mating velcro member attaches to the interior member of said cabinet and a second mating velcro member attaches to an exterior surface of said housing.

13. The apparatus of claim 11, wherein said mounting means includes at least one opening through said housing for accommodating at least one mounting screw, wherein said screw is fastened to said interior member of said cabinet.

14. The apparatus of claim 11, wherein said switching unit includes a door engagement member which extends through an opening in said housing, and a pair of contacts, wherein said door engagement member forces said contacts open when said at least one door forces said door engagement member inward.

15. The apparatus of claim 14, wherein said switching unit further includes a resilient member that forces the contacts closed when said at least one door is swung away from said door engagement member.

16. The apparatus of claim 11, wherein said switching unit further includes at least one motion sensor, said motion sensor being responsive to the movement of said at least one door.

17. The apparatus of claim 16, wherein said switching unit further includes a timer having a predetermined time set, such that when said switching unit becomes closed said switching unit automatically opens after said predetermined time set elapses.

18. The apparatus of claim 11, wherein said self contained power source further includes at least one battery.

19. The apparatus of claim 11, wherein said at least one illuminating member is selected from the group consisting essentially of an incandescent lamp and a light emitting diode.
